(19) United States
(12) Patent Application Publication
(10) Pub. No.: US 2026/0258698 A1
(43) Pub. Date: Sep. 3, 2026

(54) TELESCOPIC PET GATE

(71) Applicant: JIANGSU ZHONGHENG PET ARTICLES JOINT-STOCK CO., LTD., Yancheng City (CN)

(72) Inventor: Bin QIU, Yancheng City (CN)

(21) Appl. No.: 19/417,251

(22) Filed: Dec. 11, 2025

(30) Foreign Application Priority Data
Feb. 28, 2025 (CN) 202520341316.0

(51) Int. Cl. E06B 9/04

(52) U.S. Cl. CPC E06B 9/04

(57) ABSTRACT

The present disclosure relates to the field of pet supplies, and in particular, to a telescopic pet gate. The telescopic pet gate includes a gate frame, a gate panel with a first end rotatably connected in the gate frame, a limiting assembly connected to a second end of the gate panel, and a limiting groove disposed in the gate frame and corresponding to the limiting assembly.

### CROSS REFERENCE TO THE RELATED APPLICATIONS

This application is based upon and claims priority to Chinese Patent Application No. 202520341316.0, filed on February 28, 2025, the entire contents of which are incorporated herein by reference.

### TECHNICAL FIELD

The present disclosure relates to the field of pet supplies, and in particular, to a telescopic pet gate.

### BACKGROUND

With the improvement of living standards, more and more people like to keep pets. However, pets are prone to getting lost, escaping or being stolen. Therefore, it is necessary to dispose barriers at the doorways or corridor entrances of pet activity areas. Pet gates have thus come into being. These gates enclose the doorways or corridor entrances, making it difficult for pets to escape or go missing.

The existing pet gates have a fixed height for confining pets during use. However, gate panels need to be added or removed according to the width of the corridor entrance or doorway to be enclosed. Moreover, the components used to secure the gate panels are often inconvenient to adjust, which results in poor practicality of these pet gates.

### SUMMARY

To solve the technical problem that the widths of the existing pet gates are not adjustable, an objective of the present disclosure is to provide a telescopic pet gate.

To achieve the above objective, an embodiment of the present disclosure provides a telescopic pet gate, including:

a gate frame;

a gate panel, where a first end of the gate panel is rotatably connected in the gate frame;

a limiting assembly, where the limiting assembly is connected to a second end of the gate panel; and

a limiting groove, where the limiting groove is disposed in the gate frame, and the limiting groove corresponds to the limiting assembly.

In the above technical solution, the gate frame includes:

a first horizontal rod, where the first horizontal rod is internally provided with a slide rail;

a second horizontal rod, where the second horizontal rod is slidably connected in the slide rail;

a first vertical rod, where the first vertical rod is connected to the first horizontal rod; and

a second vertical rod, where the second vertical rod is connected to the second horizontal rod, and the second vertical rod is parallel to the first vertical rod.

In the above technical solution, the gate panel includes:

a first horizontal tube, where the first horizontal tube is rotatably connected to the first vertical rod;

a second horizontal tube, where the second horizontal tube is rotatably connected to the first horizontal rod, and the second horizontal tube is parallel to the first horizontal tube;

a first vertical tube, where two ends of the first vertical tube are respectively connected to the first horizontal tube and the second horizontal tube;

a third horizontal tube, where the third horizontal tube is slidably connected in the first horizontal tube;

a fourth horizontal tube, where the fourth horizontal tube is slidably connected in the second horizontal tube; and

a second vertical tube, where two ends of the second vertical tube are respectively connected to the third horizontal tube and the fourth horizontal tube.

In the above technical solution, the telescopic pet gate further includes:

two first sliding grooves, where the two first sliding grooves are respectively disposed in opposite surfaces of the first horizontal tube and the second horizontal tube;

a first metal mesh, where two ends of the first metal mesh are respectively connected to the first horizontal tube and the second horizontal tube; and

a second metal mesh, where two ends of the second metal mesh respectively pass through the two first sliding grooves, and the two ends of the second metal mesh are respectively connected to the third horizontal tube and the fourth horizontal tube.

In the above technical solution, the telescopic pet gate further includes:

a third vertical tube, where two ends of the third vertical tube are respectively connected to the first horizontal tube and the second horizontal tube, and the third vertical tube is parallel to the first vertical tube;

a first metal tube, where two ends of the first metal tube are respectively connected to the first vertical tube and the third vertical tube; and

a second metal tube, where a first end of the second metal tube is connected to the second vertical tube, and a second end of the second metal tube passes through the third vertical tube and is slidably connected in the first metal tube.

In the above technical solution, the telescopic pet gate further includes:

a first limiting member, where the first limiting member is connected in the third horizontal tube, and the first limiting member passes through a side wall of the third horizontal tube; and

a plurality of limiting holes, where the plurality of limiting holes are spaced apart in a side wall of the first horizontal tube.

In the above technical solution, the limiting assembly includes:

a fixing member, where the fixing member is connected to a joint of the third horizontal tube and the second vertical tube, and the fixing member is internally provided with an accommodating cavity;

a second sliding groove, where the second sliding groove is disposed in an inner wall of the fixing member;

a third sliding groove, where the third sliding groove is disposed in the inner wall of the fixing member, and the third sliding groove is connected to the second sliding groove;

a second limiting member, where the second limiting member is slidably connected in the second sliding groove, the second limiting member passes through a side wall of the fixing member adjacent to the limiting groove, the second limiting member is internally provided with a through hole, and the through hole is internally provided with a first inclined surface;

a first sliding member, where the first sliding member passes through the side wall of the fixing member, the first sliding member extends into the through hole, and a side of the first sliding member is provided with a second inclined surface cooperating with the first inclined surface;

a second sliding member, where a first end of the second sliding member is disposed in the through hole, the second sliding member is connected to the first sliding member, and a second end of the second sliding member is slidably connected in the third sliding groove; and

a spring, where the spring is disposed in the second sliding groove, and the spring is located at a side of the second limiting member away from the limiting groove.

In the above technical solution, the telescopic pet gate further includes:

a third limiting member, where the third limiting member is disposed in the accommodating cavity, the third limiting member is connected to an outer wall of the first sliding member, and the third limiting member is located outside the through hole.

Additional aspects and advantages of the present disclosure will become apparent in the following description or will be understood through the practice of the present disclosure.

### BRIEF DESCRIPTION OF THE DRAWINGS

The above and/or additional aspects and advantages of the present disclosure will become apparent and readily comprehensible from the description of embodiments with reference to the following drawings, where

FIG. 1 is a schematic front sectional view in Embodiment 1 of the present disclosure;

FIG. 2 is a schematic enlarged view of position A in Embodiment 1 of the present disclosure;

FIG. 3 is a schematic back view in Embodiment 1 of the present disclosure;

FIG. 4 is a schematic structural view of a first horizontal tube, a second horizontal tube, a first vertical tube, and a first metal mesh in Embodiment 1 of the present disclosure;

FIG. 5 is a schematic front view in Embodiment 2 of the present disclosure;

FIG. 6 is a schematic front sectional view in Embodiment 2 of the present disclosure;

FIG. 7 is a schematic structural view of a second limiting member in Embodiment 1 and Embodiment 2 of the present disclosure;

FIG. 8 is a schematic structural view of a first sliding member and a second sliding member in Embodiment 1 and Embodiment 2 of the present disclosure; and

FIG. 9 is a schematic partial sectional view of the first horizontal tube and a third horizontal tube in Embodiment 1 and Embodiment 2 of the present disclosure;

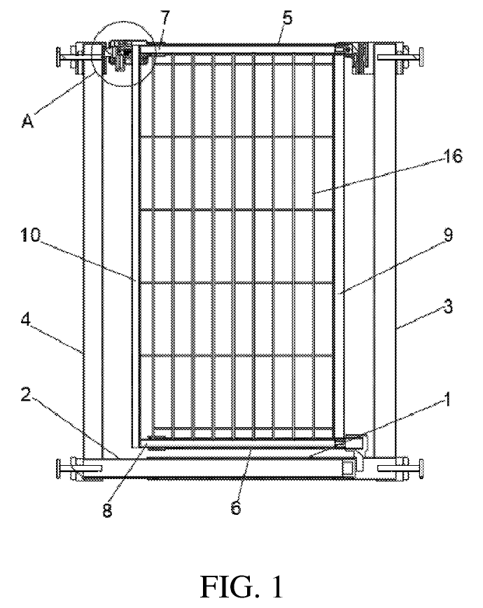

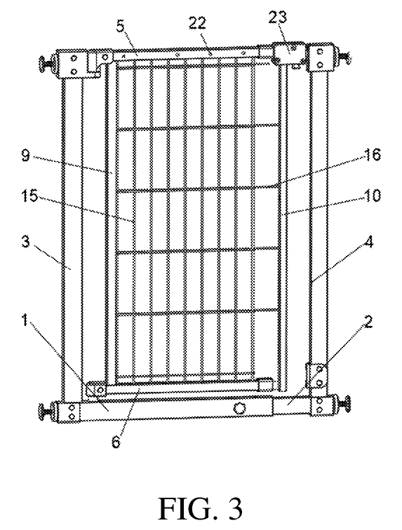

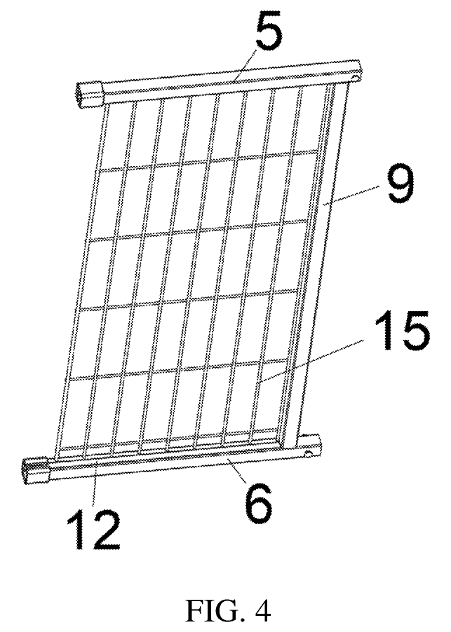

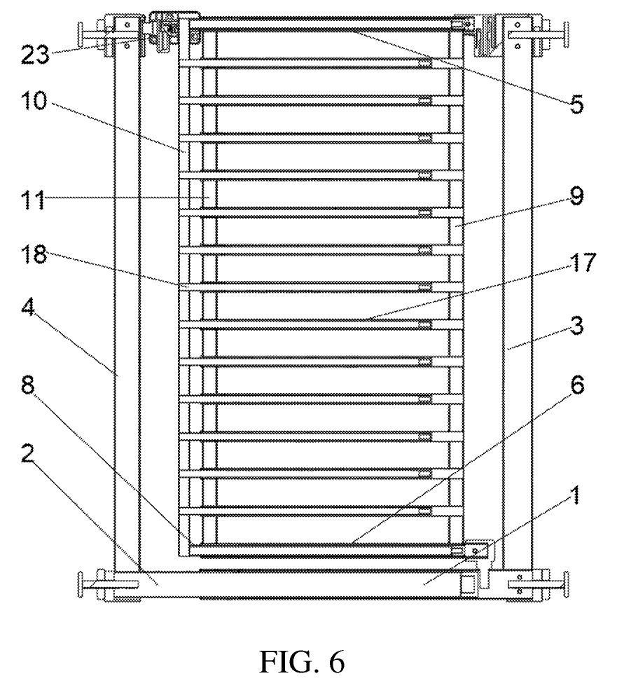

where, reference numerals in FIG. 1 to FIG. 9 are as follows:

1. first horizontal rod; 2. second horizontal rod; 3. first vertical rod; 4. second vertical rod; 5. first horizontal tube; 6. second horizontal tube; 7. third horizontal tube; 8. fourth horizontal tube; 9. first vertical tube; 10. second vertical tube; 11. third vertical tube; 12. first sliding groove; 13. second sliding groove; 14. third sliding groove; 15. first metal mesh; 16. second metal mesh; 17. first metal tube; 18. second metal tube; 19. first limiting member; 20. second limiting member; 21. third limiting member; 22. limiting hole; 23. fixing member; 24. first sliding member; 25. second sliding member; 26. spring; 27. limiting groove; 28. through hole; 29. first inclined surface; and 30. second inclined surface.

### DETAILED DESCRIPTION OF THE EMBODIMENTS

To understand the above objectives, features, and advantages of the present disclosure more clearly, the present disclosure is further described in detail below with reference to the drawings and specific implementations. It should be noted that the embodiments of the present disclosure and features of the embodiments may be combined with each other in case of no conflict.

Many specific details are set forth in the following description to facilitate a full understanding of the present disclosure. However, the present disclosure can also be implemented in other ways different from those described herein. Therefore, the protection scope of the present disclosure is not limited by the specific embodiments disclosed below.

A telescopic pet gate according to some embodiments of the present disclosure is described below according to FIG. 1 to FIG. 9.

As shown in FIG. 1 to FIG. 9, an embodiment of the present disclosure provides a telescopic pet gate, including a gate frame, a gate panel, a limiting assembly, and a limiting groove 27.

Specifically, a right end of the gate panel is rotatably connected to a right end of the gate frame. The limiting assembly is connected to an upper left end of the gate panel. The limiting groove 27 is disposed at a left end of the gate frame, and the limiting groove 27 corresponds to the limiting assembly.

When the pet gate needs to be mounted, the gate frame is first pulled towards two sides according to the actual usage requirement to extend the width of the gate frame, such that the width of the gate frame adapts to the actual mounting requirement. During this process, the width of the gate panel also extends. After the widths of the gate frame and the gate panel are extended, the two ends of the gate frame are mounted at a doorway. When the gate panel needs to be opened, the limiting assembly is slid upward, thereby opening the gate panel. When the gate panel needs to be locked, the gate panel is closed, and the limiting assembly restores to its original position, thereby locking the gate panel. The design achieves simple operation.

By configuring the gate panel and the gate frame to be telescopic, the entire structure is applicable to doorways of different widths, thereby improving the practicality of the entire structure.

### Embodiment 1

As shown in FIG. 1 to FIG. 4, in an embodiment of the present disclosure, the gate frame includes:

a first horizontal rod 1, where the first horizontal rod 1 is internally provided with a slide rail;

a second horizontal rod 2, where the second horizontal rod 2 is slidably connected in the slide rail;

a first vertical rod 3, where the first vertical rod 3 is fixedly connected to a right end of the first horizontal rod 1; and

a second vertical rod 4, where the second vertical rod 4 is fixedly connected to a left end of the second horizontal rod 2, and the second vertical rod 4 is parallel to the first vertical rod 3.

When the gate panel needs to be mounted, the second vertical rod 4 and the first vertical rod 3 are respectively pulled towards left and right sides, such that the second horizontal rod 2 slides along the slide rail. The second horizontal rod 2 gradually slides out of the slide rail until the first vertical rod 3 and a second vertical tube 10 contact an inner wall of the doorway, thereby determining positions of the first vertical rod 3 and the second vertical rod 4.

As shown in FIG. 1, in an embodiment of the present disclosure, the gate panel includes:

a first horizontal tube 5, where a right end of the first horizontal tube 5 is rotatably connected to the first vertical rod 3;

a second horizontal tube 6, where a right end of the second horizontal tube 6 is rotatably connected to the first horizontal rod 1, and the second horizontal tube 6 is parallel to the first horizontal tube 5;

a first vertical tube 9, where an upper end and a lower end of the first vertical tube 9 are respectively fixedly connected to the right end of the first horizontal tube 5 and the right end of the second horizontal tube 6;

a third horizontal tube 7, where the third horizontal tube 7 is slidably connected in the first horizontal tube 5;

a fourth horizontal tube 8, where the fourth horizontal tube 8 is slidably connected in the second horizontal tube 6;

a second vertical tube 10, where an upper end and a lower end of the second vertical tube 10 are respectively fixedly connected to a left end of the third horizontal tube 7 and a left end of the fourth horizontal tube 8;

two first sliding grooves 12, where the two first sliding grooves 12 are respectively disposed in a lower surface of the first horizontal tube 5 and an upper surface of the second horizontal tube 6;

a first metal mesh 15, where an upper end and a lower end of the first metal mesh 15 are respectively connected to the first horizontal tube 5 and the second horizontal tube 6, and a right end of the first metal mesh 15 is fixedly connected to the first vertical tube 9; and

a second metal mesh 16, where an upper end and a lower end of the second metal mesh 16 respectively pass through the two first sliding grooves 12, the upper end and the lower end of the second metal mesh 16 are respectively fixedly connected to the third horizontal tube 7 and the fourth horizontal tube 8, and a left end of the second metal mesh 16 is fixedly connected to the second vertical tube 10.

When the first vertical rod 3 and the second vertical rod 4 are pulled, the third horizontal tube 7 gradually slides out of the first horizontal tube 5, and the fourth horizontal tube 8 gradually slides out of the second horizontal tube 6, thereby extending the width of the gate panel. The width of the gate panel is extended according to the actual usage requirement, which expands the application range of the entire structure. The second metal mesh 16 can also slide along the first sliding grooves 12, such that the first metal mesh 15 and the second metal mesh 16 can prevent a pet from escaping.

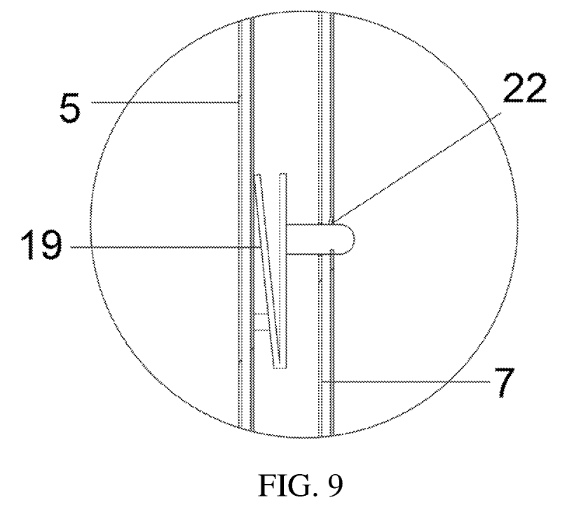

As shown in FIG. 9, in an embodiment of the present disclosure, the telescopic pet gate further includes:

a first limiting member 19, where the first limiting member 19 is fixedly connected in the third horizontal tube 7, the first limiting member 19 passes through a side wall of the third horizontal tube 7, the first limiting member 19 is a V-shaped elastic piece, the V-shaped elastic piece is provided with a protrusion, and the protrusion passes through the side wall of the third horizontal tube 7; and

a plurality of limiting holes 22, where the plurality of limiting holes 22 are disposed in a side wall of the first horizontal tube 5, the plurality of limiting holes 22 are spaced apart along a length direction of the first horizontal tube 5, and the plurality of limiting holes 22 are at a same height as the protrusion of the V-shaped elastic piece.

The V-shaped elastic piece is fixedly connected in the third horizontal tube 7, and the protrusion of the V-shaped elastic piece passes through the side wall of the third horizontal tube 7. Therefore, when the third horizontal tube 7 slides out of the first horizontal tube 5 and the fourth horizontal tube 8 slides out of the second horizontal tube 6, the protrusion of the V-shaped elastic piece contacts the inner wall of the first horizontal tube 5 during the sliding of the third horizontal tube. The inner wall of the first horizontal tube 5 exerts pressure on the protrusion, such that the V-shaped elastic piece is in a compressed state. When the third horizontal tube 7 drives the V-shaped elastic piece to move and the protrusion moves to the limiting hole 22 at the right end, the pressure on the V-shaped elastic piece decreases, such that the V-shaped elastic piece drives the protrusion to pass through the limiting hole 22 at the right end. Through the cooperation between the V-shaped elastic piece and the limiting holes 22, the first horizontal tube 5 and the third horizontal tube 7 are initially fixed to avoid relative sliding between the first horizontal tube 5 and the third horizontal tube 7, thereby fixing the first vertical rod 3 and the second vertical rod 4. The distance between the first vertical rod 3 and the second vertical rod 4 at this time is compared with the width of the doorway. If the distance between the first vertical rod 3 and the second vertical rod 4 cannot accommodate the width of the doorway, the first vertical rod 3 and the second vertical rod 4 are continuously pulled towards two sides. Since the protrusion is arc-shaped, the protrusion can re-enter the first horizontal tube 5 during the process of pulling the first vertical rod 3 and the second vertical rod 4 until the protrusion moves into the corresponding limiting hole 22 to make the distance between the first vertical rod 3 and the second vertical rod 4 accommodate the width of the doorway. Through the cooperation between the limiting hole 22 and the protrusion, the positions of the first vertical rod 3 and the second vertical rod 4 are initially fixed. This improves the stability of the first vertical rod 3 and the second vertical rod 4 during mounting, avoiding sliding of the first vertical rod 3 and the second vertical rod 4.

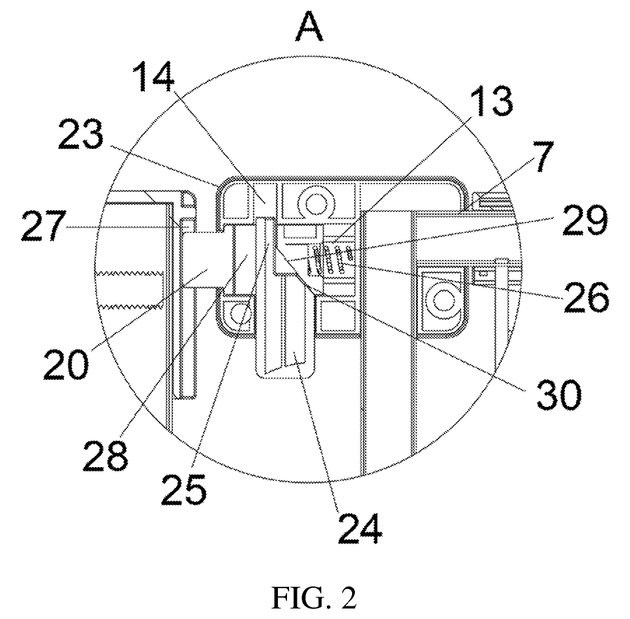

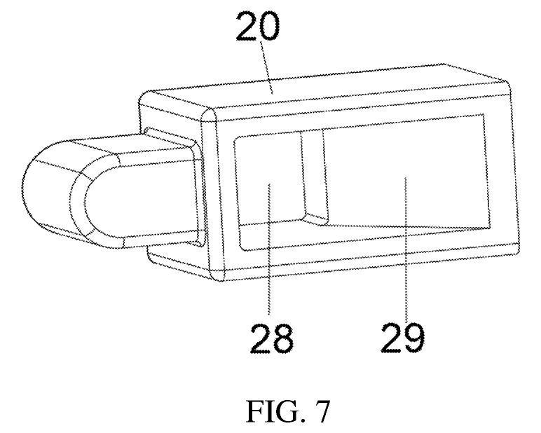

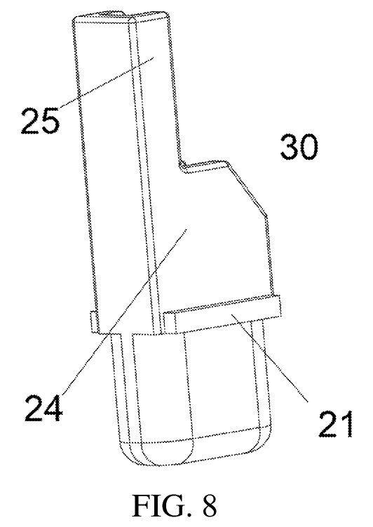

As shown in FIG. 1, FIG. 2, FIG. 7, and FIG. 8, in an embodiment of the present disclosure, the limiting assembly includes:

a fixing member 23, where the fixing member 23 is internally provided with an accommodating cavity, the left end of the third horizontal tube 7 passes through a side wall at a right end of the fixing member 23 and extends into the accommodating cavity, and the upper end of the second vertical tube 10 passes through a side wall at a bottom of the fixing member 23 and extends into the accommodating cavity; the fixing member 23 includes two housings, opposite surfaces of the two housings are open, such that the fixing member 23 is formed by splicing the two housings, and then the two housings are fixed together by a screw; when the fixing member 23 is mounted, the left end of the third horizontal tube 7 and the upper end of the second vertical tube 10 are correspondingly placed in one of the housings, and then the other housing is spliced; and the left end of the third horizontal tube 7 and the upper end of the second vertical tube 10 are clamped by the two housings, and then the two housings are fixed together by the screw to complete the mounting of the fixing member 23;

two second sliding grooves 13, where the two second sliding grooves 13 are disposed in an inner wall of the fixing member 23, the two second sliding grooves are respectively disposed in inner walls of the two housings, and the two second sliding grooves 13 are opposite to each other;

two third sliding grooves 14, where the two third sliding grooves 14 are disposed in the inner wall of the fixing member 23, the two third sliding grooves 14 are respectively disposed in side walls of the two housings, the two third sliding grooves 14 are respectively located above the two second sliding grooves 13, and the two third sliding grooves 14 are respectively connected to the two second sliding grooves 13;

a second limiting member 20, where the second limiting member 20 is slidably connected in the second sliding grooves 13, the second limiting member 20 passes through a side wall at a left end of the fixing member 23, the second limiting member 20 is provided with a through hole 28 in a vertical direction, the through hole 28 is provided with a rectangular cross-section in a horizontal direction, a right side wall of the through hole 28 is provided with a first inclined surface 29, an upper end of a right surface of the second vertical rod 4 is provided with a limiting groove 27, and the limiting groove 27 is opposite to the second limiting member 20;

a first sliding member 24, where the first sliding member 24 passes through a side wall at a lower end of the fixing member 23, the first sliding member 24 extends into the through hole 28, and an upper right end of the first sliding member 24 is provided with a second inclined surface 30 cooperating with the first inclined surface 29;

a second sliding member 25, where a lower end of the second sliding member 25 is disposed in the through hole 28, the lower end of the second sliding member 25 is fixedly connected to the first sliding member 24, and an upper end of the second sliding member 25 is slidably connected in the third sliding grooves 14; and

a spring 26, where the spring 26 is disposed in the second sliding grooves 13, and the spring 26 is disposed at a right side of the second limiting member 20.

When the gate panel is in a locked state, a left end of the second limiting member 20 extends into the limiting groove 27, and the gate panel is locked through the cooperation between the second limiting member 20 and the limiting groove 27.

When the gate panel needs to be opened, the first sliding member 24 is pushed upward. When the first sliding member 24 is pushed upward, the second inclined surface 30 is closely attached to the first inclined surface 29, and the first sliding member 24 drives the second inclined surface 30 to move vertically upward, thereby pushing the first inclined surface 29 to the right through the second inclined surface 30. Through the cooperation between the first inclined surface 29 and the second inclined surface 30, the first sliding member 24 pushes the second limiting member 20 to the right, such that the second limiting member 20 is separated from the limiting groove 27, thereby opening the gate panel. When the first sliding member 24 is pushed upward, the second sliding member 25 is driven to move upward. Specifically, the second sliding member 25 slides upward along the third sliding grooves 14. The size of the second sliding member 25 matches that of the third sliding grooves 14, and the cooperation between the second sliding member 25 and the third sliding grooves 14 plays a guiding role to avoid deviation of the first sliding member 24 during sliding. When the second limiting member 20 is pushed to the right, the spring 26 is compressed. To lock the gate panel after the gate panel is opened, the gate panel is closed to its original position. Then the first sliding member 24 is released, and the spring 26 restores its shape and drives the left end of the first limiting member 19 to enter the limiting groove 27 again, thereby locking the gate panel.

Through the above structure and principle, the gate panel is opened and locked by pushing the first sliding member 24 upward and utilizing the ability of the spring 26 to restore its shape, achieving simple operation.

As shown in FIG. 8, in an embodiment of the present disclosure, the telescopic pet gate further includes:

a third limiting member 21, where the third limiting member 21 is disposed in the accommodating cavity, the third limiting member 21 is fixedly connected to an outer wall of the first sliding member 24, the third limiting member 21 is located below the second limiting member 20, and the third limiting member 21 is disposed outside the through hole 28.

When the gate panel is locked, the third limiting member 21 is placed on an inner lower surface of the fixing member 23. Through the cooperation between the third limiting member 21 and the inner lower surface of the fixing member 23, a limiting effect is exerted on the first sliding member 24 to prevent the first sliding member 24 from sliding out of the fixing member 23 under gravity, ensuring that the first sliding member 24 can work normally.

### Embodiment 2

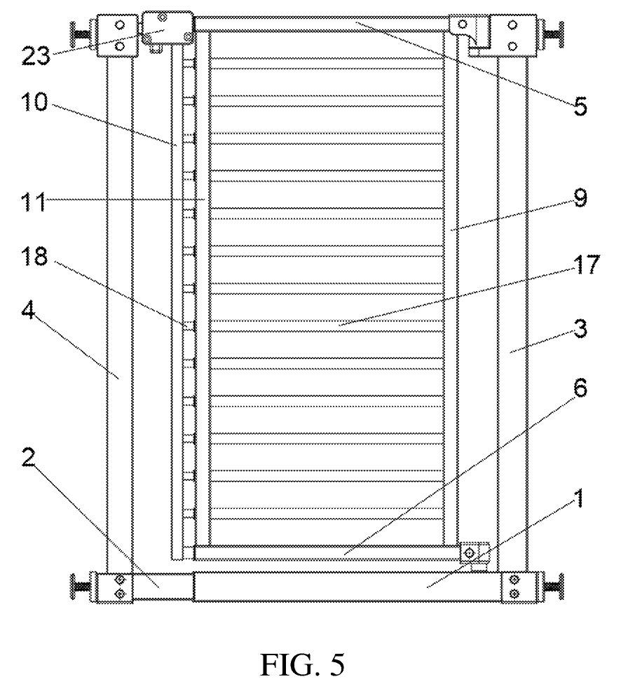

As shown in FIG. 5 to FIG. 9, in an embodiment of the present disclosure, the gate panel includes:

a first horizontal tube 5, where a right end of the first horizontal tube 5 is rotatably connected to the first vertical rod 3;

a second horizontal tube 6, where a right end of the second horizontal tube 6 is rotatably connected to the first horizontal rod 1, and the second horizontal tube 6 is parallel to the first horizontal tube 5;

a first vertical tube 9, where an upper end and a lower end of the first vertical tube 9 are respectively fixedly connected to the right end of the first horizontal tube 5 and the right end of the second horizontal tube 6;

a third horizontal tube 7, where the third horizontal tube 7 is slidably connected in the first horizontal tube 5;

a fourth horizontal tube 8, where the fourth horizontal tube 8 is slidably connected in the second horizontal tube 6;

a second vertical tube 10, where an upper end and a lower end of the second vertical tube 10 are respectively fixedly connected to a left end of the third horizontal tube 7 and a left end of the fourth horizontal tube 8;

a third vertical tube 11, where an upper end and a lower end of the third vertical tube 11 are respectively fixedly connected to a left end of the first horizontal tube 5 and a left end of the second horizontal tube 6, and the third vertical tube 11 is parallel to the first vertical tube 9;

a first metal tube 17, where two ends of the first metal tube 17 are respectively fixedly connected to the first vertical tube 9 and the third vertical tube 11; and

a second metal tube 18, where a left end of the second metal tube 18 is fixedly connected to the second vertical tube 10, and a right end of the second metal tube 18 passes through the third vertical tube 11 and is slidably connected in the first metal tube 17.

When the first vertical rod 3 and the second vertical rod 4 are pulled, the second horizontal rod 2 gradually slides out of the first horizontal rod 1, the third horizontal tube 7 gradually slides out of the first horizontal tube 5, and the fourth horizontal tube 8 gradually slides out of the second horizontal tube 6. Meanwhile, the second metal tube 18 gradually slides out of the first metal tube 17. After the positions of the first vertical rod 3 and the second vertical rod 4 are determined, the first metal tube 17 and the second metal tube 18 are relatively stationary. The first metal tube 17 and the second metal tube 18 can serve to block the pet, prevent it from escaping from a restricted area.

Other implementations in Embodiment 2 are the same as those in Embodiment 1, and will not be repeated herein.

The present disclosure has the following advantages:
1. By configuring the gate frame and the gate panel to be telescopic, the gate frame and the gate panel can extend and retract, such that the entire structure is applicable to different scenarios, thereby expanding the application range of the entire structure.
2. By disposing the limiting assembly on the gate panel to cooperate with the limiting groove 27, the limiting assembly can be pushed upward to open the gate panel and be released to lock the gate panel after the gate panel is closed, achieving simple operation.

In the present disclosure, the terms such as "provided", "connected to", "connected", and "fixed" should be comprehended in a broad sense. For example, "connected" may be comprehended as fixedly connected, detachably connected, or integrally connected, and "connected to" may be directly connected to or indirectly connected to through an intermediary. Those of ordinary skill in the art may understand the specific meanings of the above terms in the present disclosure based on specific situations.

In the description of the present disclosure, it should be understood that orientation or position relationships indicated by terms such as "inside" and "outside" are orientation or position relationships shown in the drawings, and these terms are just used to facilitate description of the present disclosure and simplify the description, but not to indicate or imply that the mentioned apparatus or elements must have a specific orientation and must be constructed and operated in a specific orientation, and thus, these terms cannot be understood as a limitation to the present disclosure.

In the description of this specification, the description with reference to the terms such as ''one embodiment'', ''some embodiments'', and ''a specific embodiment'' means that the specific features, structures, materials, or characteristics described with reference to the embodiment or example are included in at least one embodiment or example of the present disclosure. In this specification, the schematic descriptions of the above terms do not necessarily refer to the same embodiment or example. Moreover, the specific features, structures, materials, or characteristics described may be combined in any suitable manner in any one or more embodiments or examples.

The above are merely preferred embodiments of the present disclosure, and are not intended to limit the present disclosure, and various changes and modifications can be made by those skilled in the art to the present disclosure. Any modifications, equivalent substitutions, improvements, etc. made within the spirit and principle of the present disclosure should be included in the protection scope of the present disclosure.

What is claimed is:

1. A telescopic pet gate, comprising:
a gate frame;
a gate panel, wherein a first end of the gate panel is rotatably connected in the gate frame;
a limiting assembly, wherein the limiting assembly is connected to a second end of the gate panel; and
a limiting groove, wherein the limiting groove is disposed in the gate frame, and the limiting groove corresponds to the limiting assembly.

2. The telescopic pet gate according to claim 1, wherein
the gate frame comprises:
a first horizontal rod, wherein the first horizontal rod is internally provided with a slide rail;
a second horizontal rod, wherein the second horizontal rod is slidably connected in the slide rail;
a first vertical rod, wherein the first vertical rod is connected to the first horizontal rod; and
a second vertical rod, wherein the second vertical rod is connected to the second horizontal rod, and the second vertical rod is parallel to the first vertical rod.

3. The telescopic pet gate according to claim 2, wherein
the gate panel comprises:
a first horizontal tube, wherein the first horizontal tube is rotatably connected to the first vertical rod;
a second horizontal tube, wherein the second horizontal tube is rotatably connected to the first horizontal rod, and the second horizontal tube is parallel to the first horizontal tube;
a first vertical tube, wherein two ends of the first vertical tube are respectively connected to the first horizontal tube and the second horizontal tube;
a third horizontal tube, wherein the third horizontal tube is slidably connected in the first horizontal tube;
a fourth horizontal tube, wherein the fourth horizontal tube is slidably connected in the second horizontal tube; and
a second vertical tube, wherein two ends of the second vertical tube are respectively connected to the third horizontal tube and the fourth horizontal tube.

4. The telescopic pet gate according to claim 3, further comprising:
two first sliding grooves, wherein the two first sliding grooves are respectively disposed in opposite surfaces of the first horizontal tube and the second horizontal tube;
a first metal mesh, wherein two ends of the first metal mesh are respectively connected to the first horizontal tube and the second horizontal tube; and
a second metal mesh, wherein two ends of the second metal mesh respectively pass through the two first sliding grooves, and the two ends of the second metal mesh are respectively connected to the third horizontal tube and the fourth horizontal tube.

5. The telescopic pet gate according to claim 3, further comprising:
a third vertical tube, wherein two ends of the third vertical tube are respectively connected to the first horizontal tube and the second horizontal tube, and the third vertical tube is parallel to the first vertical tube;
a first metal tube, wherein two ends of the first metal tube are respectively connected to the first vertical tube and the third vertical tube; and
a second metal tube, wherein a first end of the second metal tube is connected to the second vertical tube, and a second end of the second metal tube passes through the third vertical tube and is slidably connected in the first metal tube.

6. The telescopic pet gate according to claim 3, further comprising:
a first limiting member, wherein the first limiting member is connected in the third horizontal tube, and the first limiting member passes through a side wall of the third horizontal tube; and
a plurality of limiting holes, wherein the plurality of limiting holes are spaced apart in a side wall of the first horizontal tube.

7. The telescopic pet gate according to claim 3, wherein
the limiting assembly comprises:
a fixing member, wherein the fixing member is connected to a joint of the third horizontal tube and the second vertical tube, and the fixing member is internally provided with an accommodating cavity;
a second sliding groove, wherein the second sliding groove is disposed in an inner wall of the fixing member;
a third sliding groove, wherein the third sliding groove is disposed in the inner wall of the fixing member, and the third sliding groove is connected to the second sliding groove;
a second limiting member, wherein the second limiting member is slidably connected in the second sliding groove, the second limiting member passes through a side wall of the fixing member adjacent to the limiting groove, the second limiting member is internally provided with a through hole, and the through hole is internally provided with a first inclined surface;
a first sliding member, wherein the first sliding member passes through the side wall of the fixing member, the first sliding member extends into the through hole, and a side of the first sliding member is provided with a second inclined surface cooperating with the first inclined surface;
a second sliding member, wherein a first end of the second sliding member is disposed in the through hole, the second sliding member is connected to the first sliding member, and a second end of the second sliding member is slidably connected in the third sliding groove; and
a spring, wherein the spring is disposed in the second sliding groove, and the spring is located at a side of the second limiting member away from the limiting groove.

8. The telescopic pet gate according to claim 7, further comprising:
a third limiting member, wherein the third limiting member is disposed in the accommodating cavity, the third limiting member is connected to an outer wall of the first sliding member, and the third limiting member is located outside the through hole.
